(19) United States
(12) Patent Application Publication
(10) Pub. No.: US 2006/0072849 A1
(43) Pub. Date: Apr. 6, 2006

(54) Multi-leaf collimator position sensing

(75) Inventor: Delaperriere Marc, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 10/951,534

(22) Filed: Sep. 27, 2004

(51) Int. Cl. G06K 9/36; G06K 9/00

(52) U.S. Cl. 382/291; 382/128

(57) ABSTRACT

A method for determining real positions in a multi-leaf collimator (MLC) is disclosed. A scanner or other secondary imaging device is used to acquire a series of reference images and to capture the light field when the MLC is in a particular position and has a particular geometry. The reference images are used together with the captured light field images in order to determine the real positions of the leaves in the MLC. The real positions are used to correct any calibration problems in the mechanism used to drive the leaves of the MLC.

### BACKGROUND

1. Field of the Invention

The present invention relates generally to radiation treatment, and more particularly to calibrating systems to be used during such treatment.

2. Related Art

Conventional radiation treatment typically involves directing a radiation beam at a tumor in a patient to deliver a predetermined dose of treatment radiation to the tumor according to an established treatment plan. An exemplary radiation treatment device is described in U.S. Pat. No. 5,668,847, issued Sep. 16, 1997 to Hernandez.

Tumors have three-dimensional treatment volumes which typically include segments of normal, healthy tissue and organs. Healthy tissue and organs are often in the treatment path of the radiation beam. This complicates treatment, because the healthy tissue and organs must be taken into account when delivering a dose of radiation to the tumor. While there is a need to minimize damage to healthy tissue and organs, there is an equally important need to ensure that the tumor receives an adequately high dose of radiation. Cure rates for many tumors are a sensitive function of the dose they receive. The danger is particularly great with proton beam therapy devices where the radiation dose delivered is higher and more focused than photon or electron beam therapy devices. Therefore, it is important to closely match the radiation beam's shape and effects with the shape and volume of the tumor being treated.

In many radiation therapy devices, the treatment beam is projected through a pre-patient collimating device (a “collimator”), that defines the treatment beam profile or the treatment volume at the treatment zone. A number of different collimator techniques have been developed to attempt to conform the dose rate and the treatment volume to the shape of the tumor while taking nearby healthy tissue and organs into account. A first technique is to use a collimator with solid jaw blocks positioned along a path of the treatment beam to create a field shape based on the shape of the tumor to be treated. Typically, two sets of blocks are provided, including two blocks making up a Y-jaw generally disposed parallel to a Y-axis (with the Z-axis being parallel to the beam path), and two blocks making up an X-jaw generally disposed parallel to an X-axis. The X-jaw is conventionally placed between the Y-jaws and the patient.

These solid jaw blocks, however, do not provide sufficient variability in the field shape. In particular, where the tumor has a shape which requires a field edge relatively parallel to the edge of the jaw blocks, the edge of the jaw block becomes more predominant in forming the field edge. As a result, undulation of the field increases as well as the effective penumbra. This can be particularly difficult where the treatment beam is an X-ray beam. It is also difficult to adjust the field shape where the treatment beam is an electron beam due to electron attenuation and scattering.

Multi-leaf block collimators were developed to provide more variation and control over the shape of the field at the treatment zone. An example multi-leaf collimator (MLC) is described in U.S. Pat. No. 5,591,983 issued to Hughes on Jan. 7, 1997. The Hughes collimator uses an X-jaw which has two blocks each made up of a number of individual leaves. Each of the leaves of the X-jaw can be moved longitudinally across the path of the radiation beam to create a desired beam shape at the point of treatment.

To ensure that radiation will be delivered to a proper area, a light field is used to indicate the position of a field within which radiation will be delivered. Delivery errors may occur if the light field is not located at a same position as the subsequently-produced radiation field. Accordingly, it is necessary to verify that the position of the light field accurately represents a position of the radiation field. When an MLC is present in the radiation therapy device, the leaves of the MLC must also be calibrated to ensure that there is a sufficient correspondence between the shape and dimensions of the desired radiation field and the MLC.

Typically, the calibration of the MLC has also been performed with the use of a light field. In particular, light (from a light bulb or other source) is projected through the MLC onto a paper or film (which is placed on the patient bed or couch) to create a light field. The positions of each leaf of the MLC must often be calibrated individually. The leaves are driven one-by-one (open or closed) to determined positions on the paper. The calibration of leaves can be performed manually, or automatically, however, the calibration until now has been performed manually.

The manual calibration is based upon an eye evaluation of the leaf position (evaluation of the light field penumbra) and depends upon the viewer and can thus be very subjective. For a 58 leaf MLC from Toshiba Corp., for instance, it has been estimated that a manual calibration could take up to one hour. Calibration fixtures may be mounted on the MLC, but the MLC could be damaged if they are not handled properly. The fixture is placed in the collimator and the leaves are driven against it, until they are stopped mechanically. The position is taken as reference point for the calibration.

Other electronic automatic calibration may suffer from damaging exposure to radiation and thus, may be subject to error or failure.

### BRIEF DESCRIPTION OF THE DRAWINGS

The exact nature of this invention, as well as its objects and advantages, will become readily apparent from consideration of the following specification as illustrated in the accompanying drawings, in which like reference numerals designate like parts, and wherein:

FIG. 1A is diagram illustrating a radiation therapy device;

FIG. 1B is a block diagram illustrating portions of the radiation therapy device of FIG. 1A according to one embodiment of the present invention;

FIG. 2 is a flowchart of automatic MLC calibration according to at least one embodiment of the invention;

FIG. 3 is a flowchart of automatic MLC calibration using an image device mounted in the accessory holder according to at least one embodiment of the invention;

FIG. 4 is a flowchart of automatic MLC calibration using Y-jaws as reference according to at least one embodiment of the invention;

FIG. 5 is a flowchart of automatic MLC calibration using previously stored values as reference according to at least one embodiment of the invention;

FIG. 6 illustrates an exemplary image processing routine which can be employed in at least one embodiment of the invention;

FIG. 7 illustrates at least one embodiment of the invention in which the MLC is used as a reference for calibration;

FIG. 8A-8B illustrate exemplary reference pictures used in the process of FIG. 7.

FIG. 9 illustrates the use of the reference pictures in determining angle corrections.

FIG. 10 illustrates the use of the reference pictures in determining distance correspondences.

FIG. 11 shows results of driving leaves to an exemplary calibration point.

### DETAILED DESCRIPTION

The following description is provided to enable any person of ordinary skill in the art to make and use the invention and sets forth the best modes contemplated by the inventor for carrying out the invention. Various modifications, however, will remain readily apparent to those in the art.

Some embodiments of the present invention provide a system, method, apparatus, and means to calibrate a multi-leaf collimator using a secondary image acquisition device such as a scanner to capture the shape of a projected light field on the patient bed. The calibration is based upon using the secondary image acquisition device to capture a series of reference image captures, uploading the capture data to a personal computer or image processing system, and determining calibration parameters and feeding such parameters to a control system to perform the actual adjustment of collimator leaves.

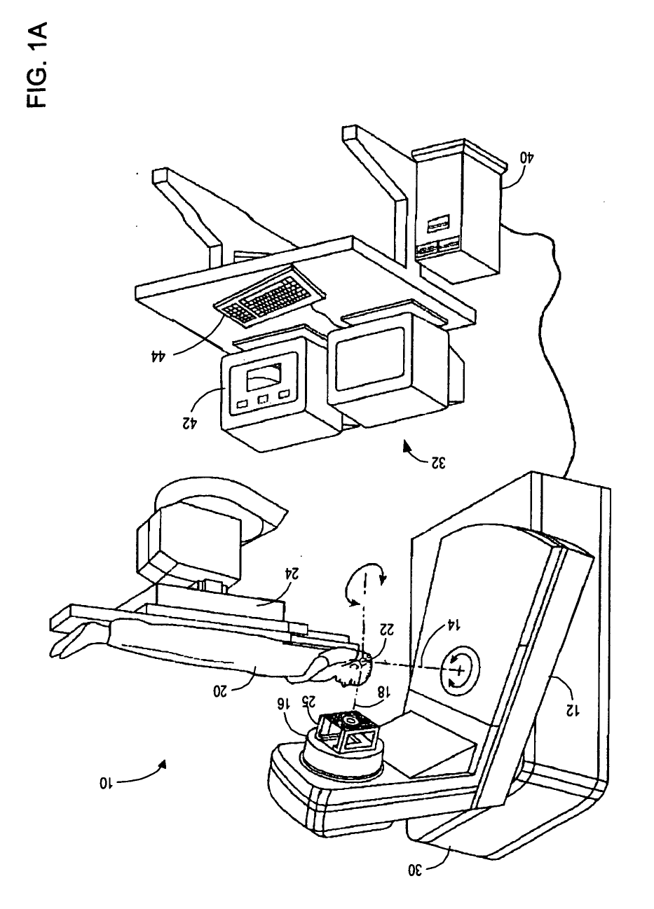

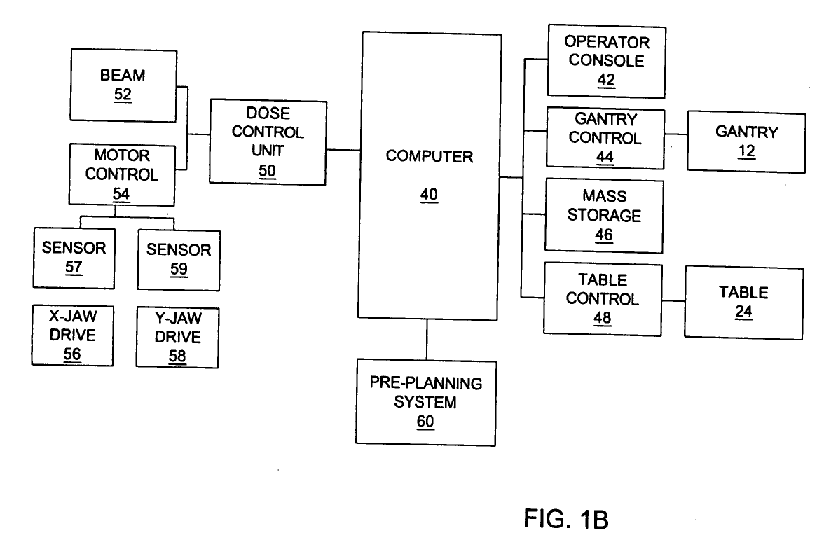

Referring first to FIG. 1A, a radiation therapy device 10 is shown in which embodiments of the present invention may be employed. Radiation therapy device 10 includes a gantry 12 which can be swiveled around a horizontal axis of rotation 14 in the course of a therapeutic treatment. A treatment head 16 (“collimator”) can be set at any angle (rotation on the z axis) of gantry 12 directs a radiation beam along axis 18 toward a patient 20. The radiation beam is typically generated by a linear accelerator positioned within gantry 12. The radiation beam may be electron or photon radiation. The radiation beam is trained on a treatment zone 22 of patient 20. Treatment zone 22 is an area which includes the tumor to be treated. A MLC (multi-leaf collimator) is placed within the treatment head 16 to shape and size the radiation beam. permit the creation and control of the radiation beam to closely match the shape and size of the treatment zone 22. Radiation therapy device 10 is in communication with other treatment elements 32 including a computer 40, operatively coupled to an operator console 42 for receiving operator control elements via a keyboard 44 and for displaying treatment data on the console 42. In accordance with at least one embodiment of the invention, a scanner or other secondary imaging device is placed where patient 20 is shown in FIG. 1A. This scanner is used to measure a light field projected through the MLC in order to calibrate the MLC. This scanner is placed on the treatment couch only to perform the calibration, at intervals this calibration is necessary. It is removed during treatments and normal operation of the linac.

Referring now to FIG. 1B, a block diagram is shown depicting a portion of a radiation therapy device 10 according to one embodiment of the present invention. In particular, treatment delivery elements of a radiation therapy device are shown, which may be configured in radiation therapy device 10 as depicted in FIG. 1A. The treatment delivery elements include a computer 40, operatively coupled to an operator console 42 for receiving operator control inputs and for displaying treatment data to an operator. Operator console 42 is typically operated by a radiation therapist who administers the delivery of a radiation treatment as prescribed by an oncologist. Using operator console 42, the radiation therapist enters data that defines the radiation to be delivered to a patient.

Mass storage device 46 stores data used and generated during the operation of the radiation therapy device including, for example, treatment data as defined by an oncologist for a particular patient. This treatment data is generated, for example, using a pre-planning system 60 which may include manual and computerized inputs to determine a beam shape prior to treatment of a patient. On some linacs, the console (computer) is connected to a verifying system (usually on a network). The mass storage and treatment planning system is somewhere on this network. Pre-planning system 60 is typically used to define and simulate a beam shape required to deliver an appropriate therapeutic dose of radiation to treatment zone 22. Data defining the beam shape and treatment are stored, e.g., in mass storage device 46 for use by computer 40 in delivering treatment.

Although a single computer 40 is depicted in FIG. 1B, those skilled in the art will appreciate that the functions described herein may be accomplished using one or more computing devices operating together or independently. Those skilled in the art will also appreciate that any suitable general purpose or specially programmed computer may be used to achieve the functionality described herein.

Computer 40 is also operatively coupled to control units including a gantry control 44 and a table control 48. In operation, computer 40 directs the movement of gantry 12 via gantry control 44 and the movement of table 24 via table control 48. These devices are controlled by computer 40 to place a patient in a proper position to receive treatment from the radiation therapy device. Gantry 12 and/or table 24 may be repositioned during treatment to deliver a prescribed dose of radiation.

Computer 40 is also operatively coupled to a dose control unit 50 which includes a dosimetry controller and which is designed to control a beam 52 to achieve desired dose delivery and dose rate. Beam 52 may be, for example, an X-ray beam or an electron beam. Beam 52 may be generated in any of a number of ways well-known to those skilled in the art. For example, dose control unit 50 may control a trigger system which generates injector trigger signals fed to an electron gun in a linear accelerator (not shown) which produces en electron beam 52 as output. Beam 52 is typically directed along an axis (as shown in FIG. 1A as item 18) toward treatment zone 22 on patient 20.

Beam 52 can be directed through a collimator assembly comprised of a Y-Jaw and an X-Jaw. Computer 40, in conjunction with dose control unit 50 or a motor control unit (not shown), controls the Y- and X-jaws using drives 56 and 58. As will be described in further detail below, X-jaw drive 56 and Y-jaw drive 58 operate independently, allowing beam 52 to be shaped with greater precision and control. X-jaw and Y-jaw drives 56 and 58 are also used to control individual elements which form the X- and Y-jaws and which will be discussed in further detail below. In some embodiments, X-jaw and Y-jaw drives 56 and 58 may also have independent hand controls to allow an operator of the radiation therapy device to adjust a beam shape by hand (e.g., during treatment pre-planning). The positions of the X and Y-jaws are controlled using drives 56 and 58 in conjunction with one or more sensors 57, 59.

In one embodiment, computer 40 may be operated to place the X- and Y-jaws in a prescribed position before treatment. According to embodiments of the invention, the position of both the X and Y-jaws may be manipulated as well as the position of the individual elements forming the X-jaws. The result is a system which allows a great degree of control over the shape of a beam at the treatment zone. For example, where the radiation beam is an X-ray beam, the position of both the X and Y-jaws and the elements forming the X-jaws can be manipulated such that surfaces of the elements and the jaws are relatively perpendicular to a long axis of the tumor being treated. As another example, where the radiation beam is an electron beam, the position of both the X- and Y-jaws can be manipulated with great accuracy to compensate for in air attenuation and scattering of the electron beam. A more precise and therapeutic beam may thus be delivered to the treatment zone.

Either or both of the X- and Y-jaws (and the individual elements of the X-jaws) may be manipulated by computer 40 during treatment to vary a shape of the beam to deliver a prescribed radiation dose to a treatment area. Further, the enhanced control of both the X- and Y-jaws (and the individual elements of the X-jaws) may also be used to deliver more precise treatment where a mixed beam modality (X-ray and electrons) is used. When a photon beam modality is used, embodiments of the present invention permit precise control over beam shape while taking into account different attenuation, scattering, and other affects for the two types of beams. Individual element positions will be determined based on a given electron energy and based on the effects of attenuation, scattering, and loss of lateral electronic equilibrium.

In various embodiments of the invention, the X-jaws are replaced or utilize a multi-element “leaf” system which has two banks of a given number of leaves each of which can be individually manipulated (open or closed) to create a more precise shape. The X-jaw drive 56 may include in this respect one or more motors, gears, levers, pulleys and other mechanical systems which can drive the leaves to a particular position. “Opening” the jaws means driving the jaw to the outside of the field (opposite direction to the symmetric jaw), “closing” means driving the jaw to the inside of the field (toward the opposite jaw). Opening and closing leaves of the MLC denotes a similar meaning.

The calibration process can be described roughly as follows. A jaw position sensor (potentiometer or encoder) provides a raw information on the position of each leaf. To match this information to real positions corresponding to field sizes, the jaws must be calibrated. For X and Y jaws (on non MLC machines), we perform scans of profiles in a water phantom. We match parameters in the console, so that the jaws opening correspond to real field sizes (measured at 50% of intensity on the profiles).

For an MLC machine (X jaws composed of leaves), scans are performed for the central leaves. Then parameters are matched so that the opening of the central leaves correspond to real field sizes. Once central leaves are calibrated, it can be determined with certainty that the position of those leaves match real field sizes. Next the process continues by aligning all the other leaves to the position of the calibrated central leaves used as reference and then calibrating them. One way to align all other leaves in respect to the central leaves is to project the shadow of these leaves on a graph paper.

The following terms are used in describing the various embodiments of the invention:

“preset leaf position”—this is the position to which it is desired to drive the leaves;
“sensor data”—row position data from potentiometer and encoder sensors after leaves are driven;
“corrected sensor data”—position of the leaves based upon sensor data feed back processed once the MLC is calibrated (or potentiometer and encoder values corresponding to that position); and

“real leaf position”—positions of the leaves obtained after imaging device image processing which correspond to actual light field measurements.

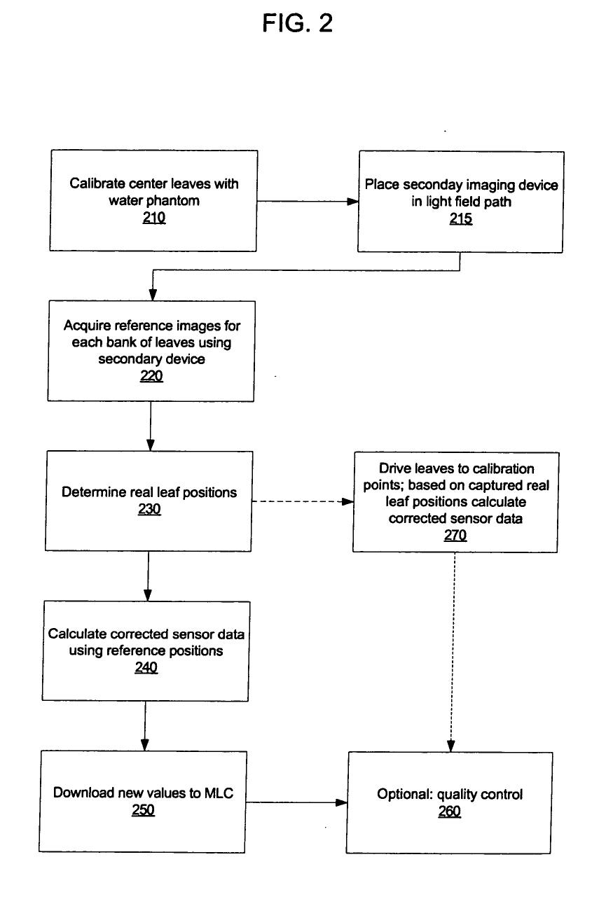

FIG. 2 is a flowchart of automatic MLC calibration according to at least one embodiment of the invention. The center leaves of the collimator are first calibrated with the use of a water phantom (block 210). The water phantom is a water tank (of 100% water) which is made to simulate a patient's body in composition (which is 75% water). It can be of a square or rectangular shape, but is generally square. The field size is measured in the water phantom at 50% intensity. The calibration of the center leaves in this manner is well-known in the art. It provides a reference for calibration of all other leaves in the collimator. Such a reference is called a “relative reference” since calibration of all other leaves is relative to the center leaves.

Next, a secondary image acquisition device is placed on the treatment bed or couch directly (or on anything else so long as it is below the collimator, on the beam/field light axis) (block 215). One example of such a device would be an A3 format scanner.

In accordance with at least one embodiment of the invention, reference images are acquired using the secondary image acquisition device for each bank of collimator leaves (block 220). In a preferred embodiment of the invention, a scanner or similar image capture mechanism can be utilized as the second image acquisition device. A flat-bed scanner can be used for this purpose. The reference image positions will be dependent upon the configuration of the MLC.

For instance, for one of the available Toshiba collimators on a PRIMUS radiotherapy system, there are two banks of 29 leaves for a total of 58 leaves. For each bank of leaves, in one exemplary embodiment, four reference images can be taken at −10 cm, 0, +10 cm and +20 cm positions, with the zero position representing the bank of leaves driven to the center of the collimator on the Y axis. The leaves are typically driven using motor and drive system to preset leaf positions. The encoder and potentiometer data are sensor data which are utilized to determine whether the leaves have moved and to what extent (actual leaf positions). While the encoder and potentiometer data are redundant (i.e. measuring the same drive action) they do not indicate the absolute motion or position of the leaves. The sensor data (counts for an encoder, feed back voltage for a potentiometer) tallied by the encoder and potentiometer provide row data, but without calibration, it is not possible to know what each count, or voltage change represents in terms of real distances. The potentiometer feed back voltage and encoder counts corresponding to leaf driving for each of the reference images taken in block 220 can be uploaded to a personal computer or other information processing/storage system. The counts may also be temporarily stored in RAM or other storage mechanisms located within or near the radiotherapy device prior to being downloaded. A protocol for the transfer of encoder and potentiometer data for calibration positions can be readily developed by one skilled in the art and may depend upon the interfacing between the MLC and the PC or processing system.

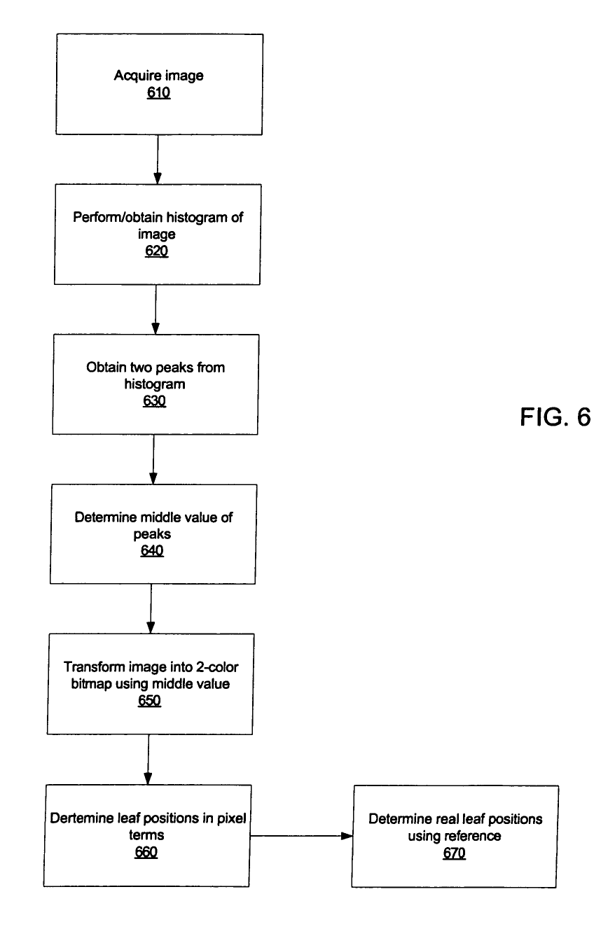

The reference images taken at block 220 can also be uploaded to a personal computer or other information processing/storage system. The next step is to determine the real leaf positions by analyzing the acquired reference images (block 230). This analysis may take the form of one or more image processing routines which are run on a personal computer or dedicated digital processor and the like. The image processing routine(s) would utilize the scanner images to obtain discrete real leaf positions. One embodiment of an image processing routine is discussed and described with respect to FIG. 6.

After processing the scanner images and determining the real leaf positions, corrected sensor data (for instance, from encoder and potentiometer values) which correspond to the four reference image positions (as determined at block 230) is calculated (block 240). The center leaves, which were calibrated with a water phantom, are used as a reference for the calculation. The corrected sensor data are then downloaded to the MLC from the PC or processing system (block 250). In alternate embodiment, blocks 240 and 250 can be replaced by block 270. The leaves can be driven to a calibration point using the real leaf positions (determined at block 230) and then corrected sensor data are determined, through a capture of actual position at this point (block 270). The physicist, technician or radiotherapy operator can then confirm the settings by some manual or automatic quality control process.

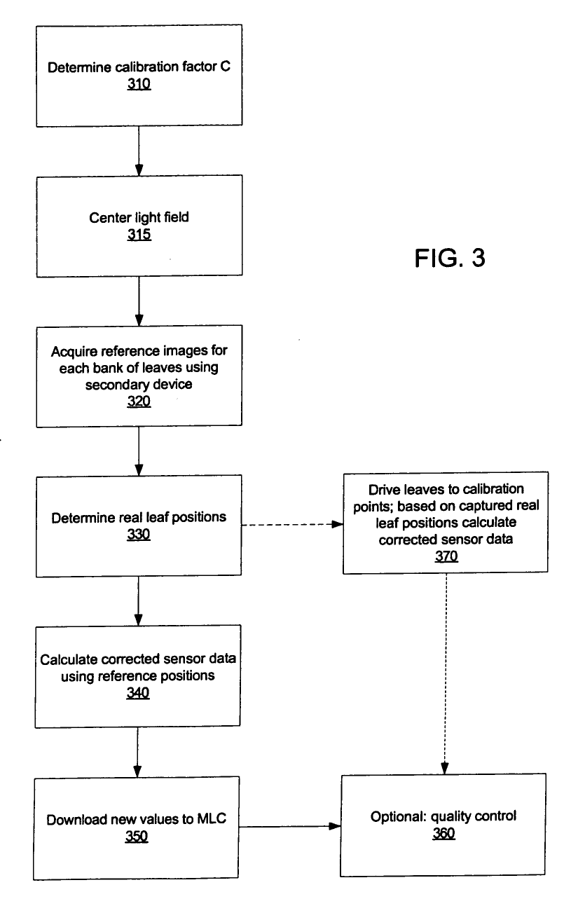

FIG. 3 is a flowchart of automatic MLC calibration using an image device mounted in the accessory holder according to at least one embodiment of the invention. The flowchart of FIG. 3 involves a special device called an accessory holder which is attached to the radiotherapy device. The distance between the scanner placed in the accessory holder and the MLC is fixed. The accessory holder and the MLC are both perpendicular to the z-axis. Block 320 is similar in all respects to block 220 of FIG. 2 as described above, except that the secondary image acquisition device is now on the accessory holder. Block 330 is identical to block 230 of FIG. 2 as described above. Block 340 is identical to block 240 of FIG. 2 as described above. Block 350 is identical to block 250 of FIG. 2 as described above. An alternate block 370 can be used instead of blocks 340 and 350 in a similar manner as block 270 of FIG. 2. Block 360 is identical to block 260 of FIG. 2 as described above.

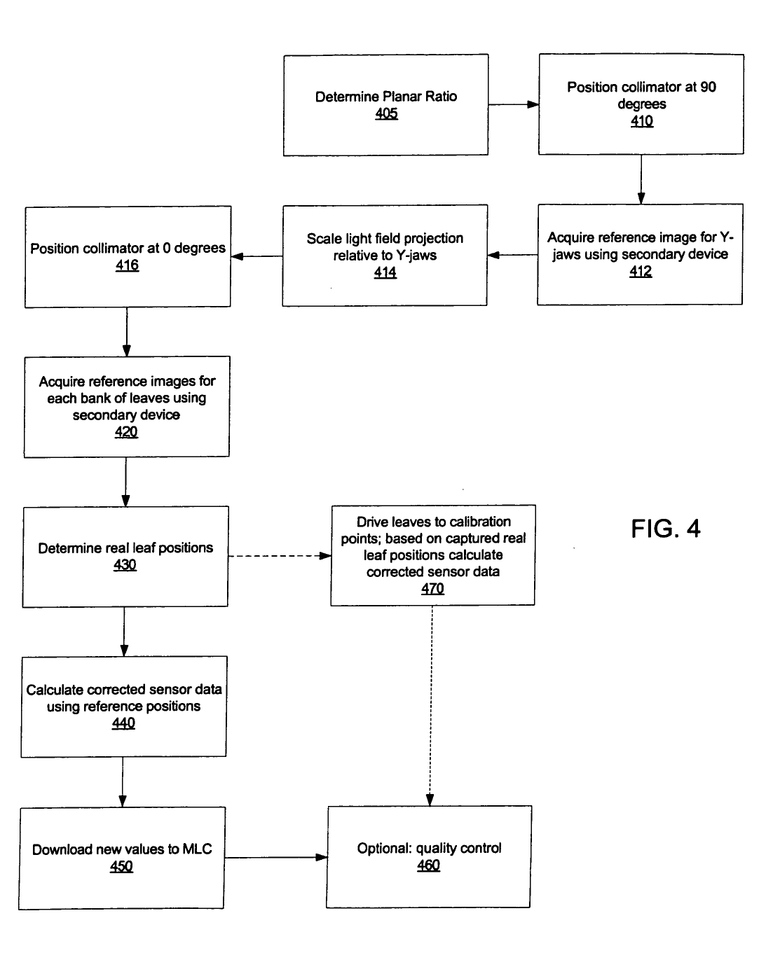

FIG. 4 is a flowchart of automatic MLC calibration using Y-jaws as reference according to at least one embodiment of the invention. In this case, it is again assumed that, as with the workflow of FIG. 2, the scanner is placed on the treatment couch or patient bed (in the beam/light field path). As a prerequisite, it is assumed that the light field is centered with respect to the radiation field, that the Y jaws are concentric when rotating the collimator and is calibrated with water phantom measurements. First, a Ratio of the inplane to crossplane is determined (block 405). This is used to determine any distortions in the way the Y-jaws correspond to the radiation field and the way the X-jaws correspond to the radiation field. For example, if the light field is 19.6 cm for a 20 cm radiation field size and 19.8 cm for a 20 cm field size on the Y jaws, then there is an inplane/crossplane distortion. The Ratio can be defined as the inplane (y-direction) divided by the crossplane (x-direction) field sizes.

The MLC is then rotated 90 degrees (through the collimator rotation axis) (block 410). Next, a reference image is obtained for the Y-jaws using the secondary image acquisition device (in one embodiment, a flatbed scanner) (block 412). The next step is to scale the light field by analyzing the acquired Y-jaw reference image (block 414).

Once the light is centered with respect to the Y-jaws, the MLC is rotated back again to the zero degree position such that the MLC projection is on the x-axis (block 416). Block 420 is similar in all respects to block 220 of FIG. 2 as described above. Block 430 is similar in all respects to block 230 of FIG. 2 as described above. Block 440 is similar in all respects to block 240 of FIG. 2 as described above, except that the Y-jaws actual positions are used as the reference for determining what sensor data corresponds with actual leaf positions. Block 450 is similar in all respects to block 250 of FIG. 2 as described above. An alternate block 470 can be used instead of blocks 440 and 450 in a similar manner as block 270 of FIG. 2. Block 460 is similar in all respects to block 260 of FIG. 2 as described above.

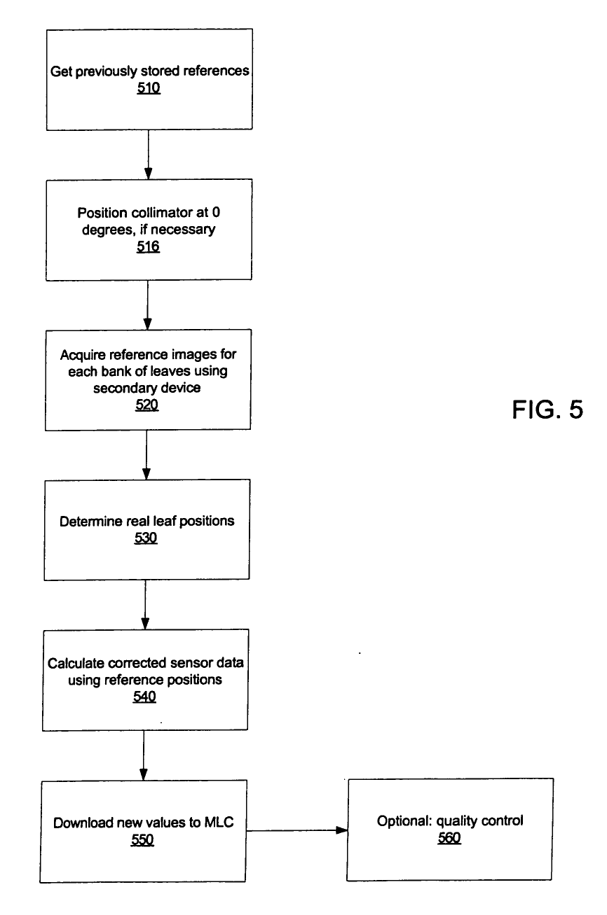

FIG. 5 is a flowchart of automatic MLC calibration using previously stored values as reference according to at least one embodiment of the invention. Previously stored values for sensor data corresponding to the reference positions are first fetched (block 510). These values may be stored in the same system or PC which computes the sensor data or in another storage mechanism or system as desired. The collimator is positioned at 0 degrees if necessary (block 516).

Block 520 is similar in all respects to block 220 of FIG. 2 as described above. Block 530 is similar in all respects to block 230 of FIG. 2 as described above. Block 540 is similar in all respects to block 240 of FIG. 2 as described above, except that the stored positions are used as the reference for determining what sensor data corresponds with real leaf positions. Block 550 is similar in all respects to block 250 of FIG. 2 as described above. Block 560 is similar in all respects to block 260 of FIG. 2 as described above.

FIG. 6 illustrates an exemplary image processing routine which can be employed in at least one embodiment of the invention. According to block 610, an image is acquired by a scanner or other source in grayscale. For instance, a 256 level grayscale image could be acquired, or a full-color image could be converted into an image with a predetermined number (such as 256) levels of gray. The routine then performs or obtains from another source a histogram of the image (block 620). Two peaks of the histogram, one for the lightened areas, and one for the shadow areas, is then obtained (block 630). The middle value between the two peaks is taken to be the 50% value of intensity (block 640). The image is then transformed into a two-color bitmap based upon whether the values falls above or below the middle intensity value (block 650). The software then determines the leaf positions on the image in terms of pixel values (block 660). Using the reference values from the center leaves, or Y-jaws references, for example, real leaf positions can be obtained (block 670). Linear transformations can then be used to calculate corrected sensor data.

The utilization of a scanner or other secondary image acquisition device to automate the leaf calibration process can be extended to other applications as well. Other potential applications include checking for deviation between leaf positions as seen/observed at the operator's console and the real/actual field positions, concentricity of Y-jaws and the MLC, and light field and position checks at different gantry angles.

In other embodiments of the invention, it may be possible to determine leaf positions on a MLC regardless of the device used to capture reference images. In such embodiments, the MLC would be used as a reference rather than the Y-jaws or the center leaves as with other methods. In such embodiments, either a scanner measuring the light field or a detector array measuring an X-ray field could be used to capture reference images. If a scanner is used, the scanner light field and radiation field do not exactly have to coincide. The scanner may simply be centered on the patient bed or treatment couch by the user.

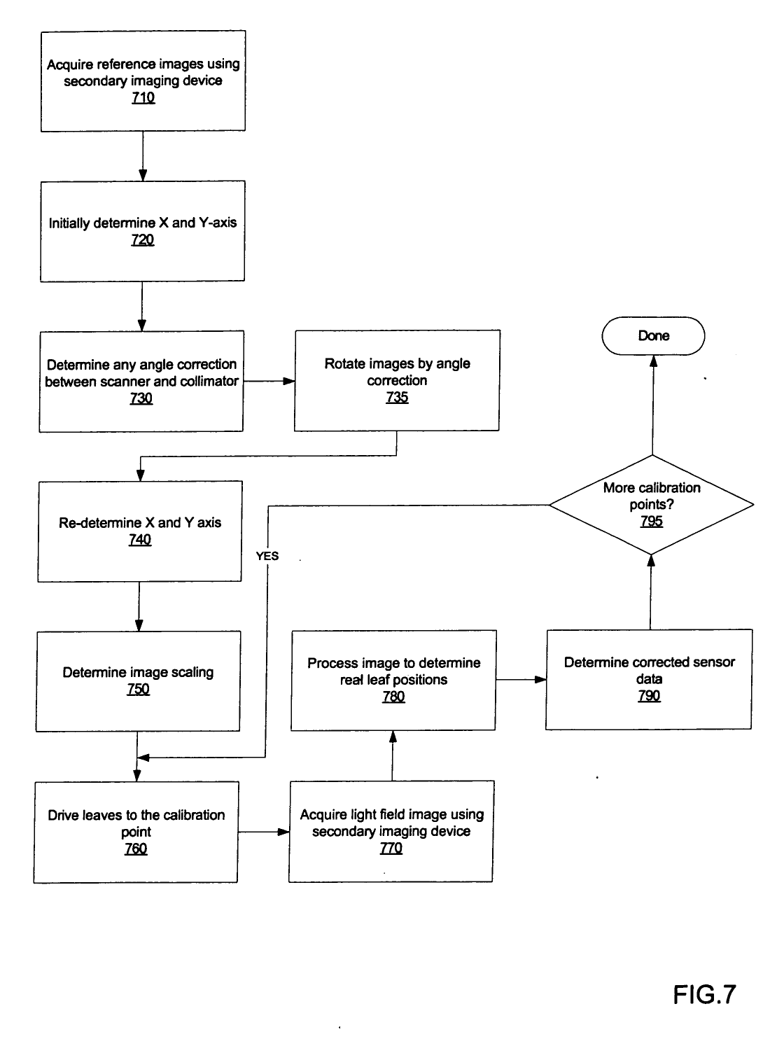

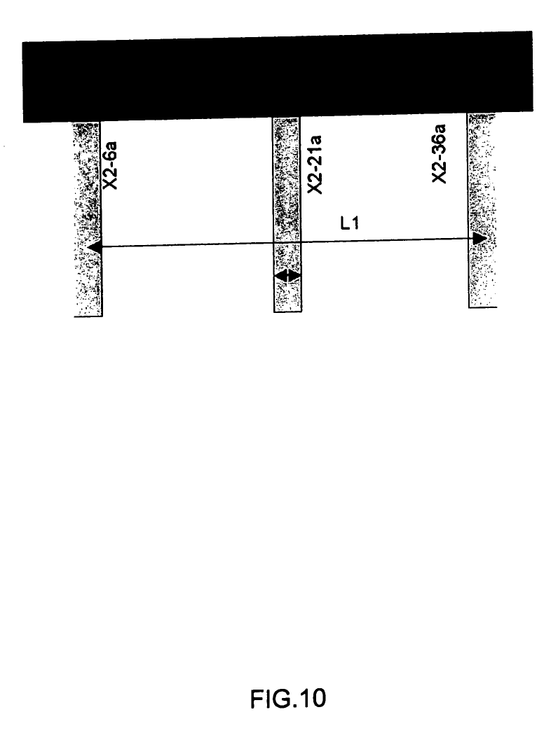

FIG. 7 illustrates at least one embodiment of the invention in which the MLC is used as a reference for calibration. The first step is to acquire a series of references images using a scanner, detector array or other imaging device (block 710). In the case of a scanner or other removable imaging device, the device can be placed and centered on the patient bed. In one embodiment of the invention, at least 2 reference images are taken, as will be described in more detail below. In the case of a scanner as the imaging device, the images obtained have to be converted to a two-color or similar bitmap so that discrete light and dark areas can be estimated. The next step after the images are acquired (and if necessary converted) is to make an initial determination of the X-axis (block 720). Then a correction angle, if any, is determined which can be applied to the images (block 730). After the angle correction both the X-axis and Y-axis are determined again (block 740). The scaling for the images are then determined using the reference images (C0 and C1) (block 750). The determination of scale (from light field projection to collimator) is described and illustrated with respect to FIG. 10 below.

Next the leaves are driven to predetermined calibration point (block 760). For instance, using the above example the leaves can be driven (closed) to say the −10 cm position. Ideally, all of the leaves are driven simultaneously or contemporaneously to speed up the calibration process. Each of the motors is directed to drive each of the leaves (or pair leaves) which it controls to this calibration point. This is present leaf position. Next, a light field image of the field created by the driven leaves is acquired using the secondary imaging device (block 770). The acquired image is then processed to determine the real leaf positions. This is the position to which the leaves in fact are driven relative to the reference images acquired at block 710. The real leaf positions enable determination of corrected sensor data (block 790). The corrected sensor data can be obtained using a simple linear transformation of the real leaf position and the calibration point. An example is given below. This process of driving leaves to calibration points and obtaining corrected sensor data, shown in blocks 760 through 790 is repeated until there are no more calibration points (checked at block 795). Corrected sensor data may uploaded to an MLC cabinet or other data storage mechanism as desired or written to and stored in file accessible by MLC drive controls and drive software.

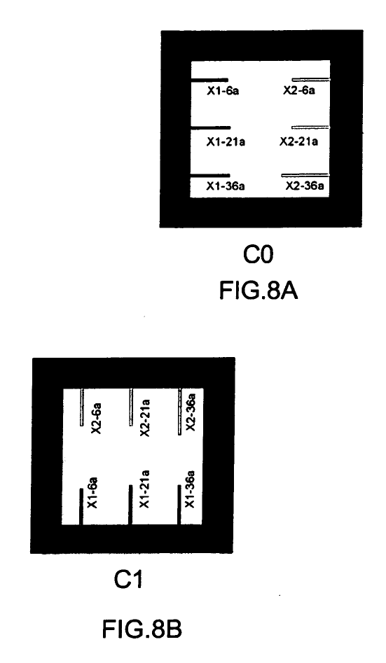

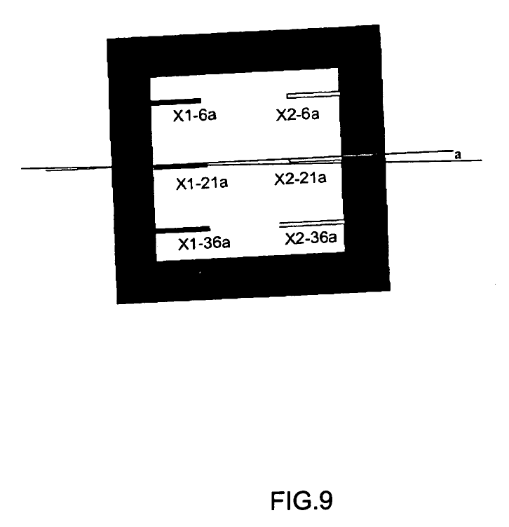

To illustrate refer to FIGS. 8(A)-(B) and the following description. A reference image C0 is acquired (block 710) as shown in FIG. 8A for example. The picture C0 is acquired with the MLC at the zero degree position of rotation and the Y-jaws completely open. For acquiring C0, the MLC is also open except for a pair of center leaves (one on each side). Also, for C0 a symmetric pair of leaves on both sides relative to the center leaf is closed (driven to the center). An exemplary calibration picture C0 is shown in FIG. 8B. For instance on an 82 leaf MLC, there are 41 leaves per bank, such that the 21st leaf can be the center leaf. A symmetric pair of leaves on either side, such as the 6th leaves and 36th leaves in MLC (15 leaves apart from the center leaf (21) on either side), can be chosen as well. For a 58 leaf MLC, the 15th pair of leaves would be chosen as the center leaves. The X-axis can be determined (block 720) initially by finding the alignment of the center leaves on the C0 reference. Likewise, a reference image C1 is acquired (block 710) which uses the same leaf arrangement as C0 except that the entire MLC is rotated 90 degrees. The Y-axis can be determined (block 720) initially by finding the alignment of the center leaves on the C1 picture. The C0 reference image can also be used to find the angle correction (block 730). This is shown in FIG. 9. The angle “a” is the correction angle by which all pictures acquired in block 710 will have to be adjusted. The angle “a” is determined as the angle formed between a horizontal line drawn across the C0 image starting at the top edge of the center leaf and the line from that top edge which follows the angle of inclination of the image of the center leaf. All of the pictures used are rotated by this angle “a”.

The C1 reference image can be used to calibrate the X-axis and find the correspondence between real distances and distances on the scanner image. The distance between the middle of two leaves symmetric about the center leaf is a known physical distance. By measuring the same dimension on the C1 image (L1 on FIG. 10), a centimeter to pixel (scanner image distance) correspondence can be obtained. This indicates the scale of the light field image as acquired versus the size of the actual MLC. The scaling factor can be derived by dividing L1, which is the measured light field distance between the image of the two leaves, by the known, fixed physical distance between the actual two leaves on the MLC. The scaling factor can be utilized in image processing during calibration and in determining physical distances versus light field distances.

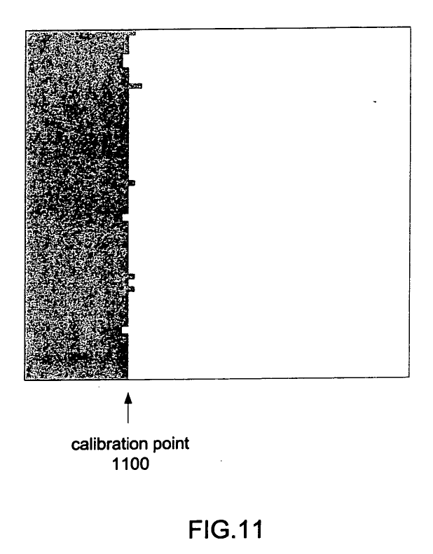

Results of driving leaves to an exemplary calibration point is shown in FIG. 11. After taking reference images as discussed above, a calibration point 1100 is specified to which all or some of the leaves are driven. Each leaf or pair of leaves is driven by an individual drive mechanism such as a motor and gear system. The drive mechanism is instructed to move the leaf (or pair) that it controls to the calibration point 1100. Some leaves in fact actually are driven to the calibration point 1100, while others are driven short of the calibration point 1100, while still others may be driven past the calibration point 1100. As shown in FIG. 11 an image of the field created once leaves are attempted to be driven to the calibration point is acquired. In accordance with the invention, this image can be acquired by a secondary imaging device such as a flatbed scanner. The acquired image is subjected to image processing. The image processing may include Gaussian filtering to remove noise. The acquired image may also be angle corrected in accordance with reference image angle correction determination (by the angle “a” described above and shown in FIG. 9). The real leaf positions are then determined from the image. The real leaf position for each leaf is the position of the leaf as determined by the light field measurements and may not be the same as the preset leaf position (the calibration point 1100, e.g.) to which it was attempted to have been driven. The difference between enables calculation of a corrected sensor data for the leaf. The corrected sensor data indicates how to instruct the drive mechanism for a given leaf in order that the real leaf position equals the preset leaf position (within tolerances). An exemplary table of these positions and calculations is shown below.

| | Calibration point | Real leaf | Corrected |
|---|---|---|---|
| Leaf | (preset leaf position) | position | sensor data |
| X1.1 | 10.0 | 10.1 | 9.9 |
| X1.2 | 10.0 | 10.0 | 10.0 |
| X1.3 | 10.0 | 10.3 | 9.7 |
| X1.4 | 10.0 | 9.8 | 10.2 |
| . | | | |
| . | | | |
| . | | | |
| X1.40 | 10.0 | 10.0 | 10.0 |
| X1.41 | 10.0 | 9.8 | 10.2 |

A leaf X1.1 was attempted to be driven to the preset leaf position 10.0 units (for example, centimeters). However, after driving is complete, image processing of the light field indicates that the real leaf position is 10.1 units. The leaf had been driven 0.1 units past the calibration point. Thus, this difference is used as a correction factor such that the corrected sensor data is 9.9 (10.0-0.1). The leaf X1.2 had a measured real leaf position of 10.0 which was the intended position, so no correction term is needed. The corrected sensor data is 10.0 (10.0-0.0) for leaf X1.2. Leaf X1.3 has a corrected sensor data of 9.7, and so on. In general, to summarize, for a given calibration point CP, with a real leaf position RL, the corrected sensor data CSD is determined by CSD=CP−(RL−CP). The process can be repeated for as many calibration points as desired. The correction factor may be linear or non-linear over the set of possible calibration points depending upon the response of the drive mechanism.

The accuracy of the corrected sensor data and real leaf positions will depend upon the resolution of the imaging device. For many applications, the resolution of a typical flat-bed scanner is more than sufficient to give good accuracy. The use of a secondary imaging device such as a scanner eliminates the need for complicated sensors, position detectors and other mechanisms that attempt to directly determine the calibration of leaves. The table of corrected sensor data or the correspondence of these positions to encoder counts or potentiometer voltages are can be stored in the MLC cabinet or similar mechanism. The counts/voltage can be adjusted by a linear transformation based upon the corrected sensor data so that when a particular leaf is subsequently driven, it can be driven such that it is calibrated to its preset leaf position.

In alternate embodiments of the invention, the methods and processes described above could be applicable to photo beam projections and photon fields as well. Similar to the light field reference images can be taken of the photon field that is projected. Calibration of the MLC can likewise be done based upon driving the leaves of the MLC to calibration points and then analyzing the photon field that results.

Those in the art will appreciate that various adaptations and modifications of the above-described embodiments can be configured without departing from the scope and spirit of the invention. For example, embodiments of the present invention may differ from the description of process steps. In addition, the particular arrangement of process steps is not meant to imply a fixed order to the steps; embodiments of the present invention can be practiced in any order that is practicable.

Therefore, it is to be understood that, within the scope of the appended claims, the invention may be practiced other than as specifically described herein.

What is claimed is:

1. A method for determining a real position of a field limiting mechanism whose position and geometry can be estimated using light projected about said field limiting mechanism, comprising:
placing an imaging device in the path of a light field created by said light projected about said field limiting mechanism;
acquiring at least one image of said light field using said imaging device; and
determining said real position of said field limiting mechanism from said acquired image.

2. A method according to claim 1 further comprising:
acquiring a plurality of reference images using said imaging device to determine alignment of said imaging device in relation to said field limiting mechanism.

3. A method according to claim 1 wherein said imaging device is a scanner.

4. A method according to claim 3 wherein said imaging device is a flat-bed scanner.

5. A method according to claim 1 wherein said field limiting mechanism is a multi-leaf collimator for collimating the radiation field produced a radiotherapy system.

6. A method according to claim 2 wherein said alignment includes axial alignment and angular alignment.

7. A method according to claim 6 wherein said at least one image of said light field is angle corrected based on said angular alignment.

8. A method according to claim 5 further comprising:
attempting to drive at least one leaf of said multi-leaf collimator to a predetermined calibration point; and
determining the difference between said predetermined calibration point and said determined said real position for each of said at least one leaf.

9. A method according to claim 8 wherein said difference is utilized to calibrate a drive mechanism responsible for said attempting to drive said at least one leaf.

10. A method according to claim 1 wherein said determining includes:
filtering out noise from said at least one image; and
processing said at least one image to approximately determine which portions of said at least one image do not show said light projected about said mechanism.

11. A method according to claim 10 wherein said filtering includes Gaussian filtering.

12. A method according to claim 10 wherein said processing includes:
performing a histogram of said at least one image;
determining a plurality of peaks for said histogram; and
using the determined peaks to convert said image into a bitmap image.

13. A method according to claim 2 further comprising:
determining a scale of projection between said light field and said field limiting mechanism; and
scaling said at least image in accordance with said determined scale.

14. A method according to claim 6 wherein said axial alignment is re-determined taking said angular alignment into account.

15. A method according to claim 8 wherein said attempting to drive and determining the difference is repeated for a plurality of different calibration points.

16. A method according to claim 2 wherein said reference images are obtained by:
placing said mechanism into a predetermined position and geometry;
projecting light about said mechanism such that the light and the absence of light due to said mechanism limiting said light can be imaged by said imaging device.

17. A method for determining a real position of a field limiting mechanism whose position and geometry can be estimated using a photon beam projected about said field limiting mechanism, comprising:
placing an imaging device in the path of a photon beam created by said light projected about said field limiting mechanism;
acquiring at least one image of said photon field using said imaging device; and
determining said real position of said field limiting mechanism from said acquired image.

18. A method according to claim 17 further comprising:
acquiring a plurality of reference images using said imaging device to determine alignment of said imaging device in relation to said field limiting mechanism.

19. A method according to claim 17 wherein said field limiting mechanism is a multi-leaf collimator for collimating the radiation field produced a radiotherapy system.

20. A method according to claim 18 wherein said alignment includes axial alignment and angular alignment.

21. A method according to claim 20 wherein said at least one image of said photon field is angle corrected based on said angular alignment.

22. A method according to claim 19 further comprising:
attempting to drive at least one leaf of said multi-leaf collimator to a predetermined calibration point; and
determining the difference between said predetermined calibration point and said determined said real position for each of said at least one leaf.

23. A method according to claim 22 wherein said difference is utilized to calibrate a drive mechanism responsible for said attempting to drive said at least one leaf.

24. A method according to claim 18 further comprising:
determining a scale of projection between said photon field and said field limiting mechanism; and
scaling said at least image in accordance with said determined scale.

25. A method according to claim 16 wherein said predetermined position is the position of open and closed leaves of said field limiting mechanism.

26. A method according to claim 18 wherein said reference images are the images produced by a radiation beam projection onto said imaging device, said radiation beam projection through open and closed leaves of said field limiting mechanism.
